(19) United States
(12) Patent Application Publication
(10) Pub. No.: US 2009/0276795 A1
(43) Pub. Date: Nov. 5, 2009

(54) VIRTUAL AUTOMATA

(75) Inventors: John Wesley Dyer, Monroe, WA (US); Brian C. Beckman, Newcastle, WA (US); Henricus Johannes Maria Meijer, Mercer Island, WA (US); Jeffrey Van Gogh, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/112,461

(22) Filed: Apr. 30, 2008

(51) Int. Cl. G06F 9/45

(52) U.S. Cl. 719/332

(57) ABSTRACT

Computer-based machines can be modeled after a virtual automaton. The virtual automaton defines processes that are not bound statically to particular behavior but rather perform a lookup at runtime to bind behavior to a specific process mechanism. In accordance with one aspect, binding can be dependent upon runtime context information such as object type. Instances of virtual automaton are provided in the context of graph processing including serialization of object graphs and scanning/parsing, among others.

### BACKGROUND

An automaton is an abstract model for a finite state machine or simply a state machine. A state machine consists of a finite number of states, transitions between those states, as well as actions. States define a unique condition, status, configuration, mode, or the like at a given time. A transition function identifies a subsequent state and any corresponding action given current state and optionally some input. In other words, upon receipt of input, a state machine can transition from a first state to a second state, and an action or output event can be performed as a function of the new state. A state machine is typically represented as a graph of nodes corresponding to states and optional actions and arrows or edges identifying transitions between states.

A pushdown automaton is an extension of a regular automaton that includes the ability to utilize memory in the form of a stack or last in, first out (LIFO) memory. While a normal automaton can transition as a function of input and current state, pushdowns can transition based on the input, current state, and stack value. Furthermore, a pushdown automaton can manipulate the stack. For example, as part of a transition a value can be pushed to or popped off a stack. Further yet, the stack can simply be ignored or left unaltered.

Automata are models for many different machines. In particular, automata lend themselves to program language processing. In one instance, automata can provide bases for various compiler components such as scanners and parsers. Scanners perform lexical analysis on a program to identify language tokens and parsers perform syntactic analysis of the tokens. Both are implemented utilizing automata that accept all language strings and no more in accordance with a language grammar. Input and tokens can either be accepted or rejected based on a resultant state upon stopping of the automaton.

Automata can also be employed to perform serialization and deserialization. Here, automata can be used to transform object graphs into a transfer syntax and subsequently reconstitute the objects graphs from the transfer syntax. Similar to compiler functionality, object graphs and serialized data can be scanned and parsed while also generating appropriate output.

In addition, automata lend themselves to workflow due at least in part to their state transitioning nature. Workflow refers generally to automation of organizational processes (e.g., business process automation). Automata can be utilized to model workflow states and transitions between states to effect process automation.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to virtual automata and specific instances thereof. More specifically, a virtual automaton defines a process whose implementation or behavior is not bound statically but rather dynamically at runtime. Late binding and indirection provide flexibility since process mechanisms can be added, removed, or altered at any time without affecting the overall process. Furthermore, such processing mechanisms can be acquired as needed, consequently providing lightweight machines, systems, or applications as well as enabling interactions across different execution contexts or environments, among other things. Although not limited thereto, in accordance with an aspect of this disclosure, virtual automata are described in the context of graph processing applications including, among others, scanning/parsing and serialization/deserialization.

In accordance with an aspect of the disclosure, serialization and its dual deserialization are focused on mechanisms independent of a particular transfer or wire format. Among other things, this allows transfer formats to be easily plugged in and employed. Furthermore, abstracting from the transfer format, mechanisms are provided for efficient breaking of cycles utilizing a depth-first navigation and dependent navigation identifiers enabling one pass serialization and streaming, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a graph processing system in accordance with an aspect of the disclosed subject matter.

FIG. 2 is a block diagram of a representative process component according to a disclosed aspect.

FIG. 3 is illustrates an exemplary a depth-first traversal of a graph by navigation component.

FIG. 4 is a block diagram of a representative extension component according to an aspect of the disclosure.

FIG. 5 is a block diagram of a serialization system according to a disclosed aspect.

FIG. 6 illustrates an exemplary graph in accordance with an abstract syntax to facilitate clarity with respect to aspects of the disclosure.

FIG. 7a-b depict a graph and tree associated with a serialization example disclosed herein.

FIG. 8 is a block diagram of a parsing/scanning system in accordance with an aspect of the disclosed subject matter.

FIG. 9 is a flow chart diagram of a method of graph processing in accordance with an aspect of the disclosure.

FIG. 10 is a flow chart diagram of a method of extending processing according to a disclosed aspect.

FIG. 11 is a flow chart diagram of a method of process mechanism generation in accordance with an aspect of the disclosure.

FIG. 12 is a flow chart diagram of a method for provisioning a process mechanism according to a disclosed aspect.

FIG. 13 is a flow chart diagram of a serialization method in accordance with an aspect of the disclosure.

FIG. 14 is a flow chart diagram of a graph serialization method in accordance with a disclosed aspect.

FIG. 15 is a flow chart diagram of a graph-based deserialization method according to an aspect of the subject disclosure.

FIG. 16 is a schematic block diagram illustrating a suitable operating environment for aspects of the subject disclosure.

FIG. 17 is a schematic block diagram of a sample-computing environment.

### DETAILED DESCRIPTION

Systems and methods pertaining to virtual automata are described in detail hereinafter. Conventional automata functionality or behavior can be bound at runtime as a function of type and/or other context information, for example. Among other things, virtualization in one or more dimensions provides significant and valuable extensibility to machines modeled in this manner. Although not limited thereto, this broadly defined category of machines is described herein within the context of graph processing and specific instances in which graph processing can be employed. One particular and concrete instance concerns serialization and deserialization of object graphs for transmission and storage to and amongst processing entities. Other instances include parsing, scanning, and workflow, among others.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

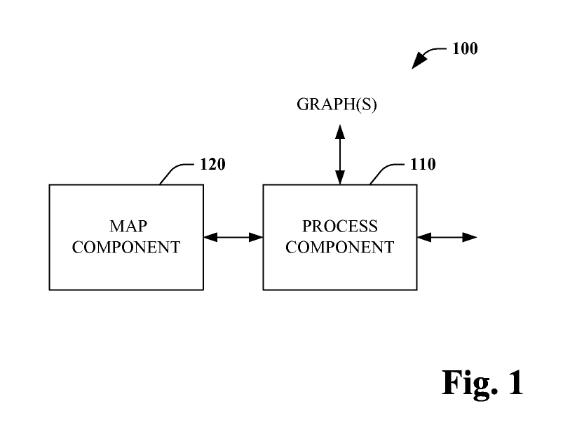

Referring initially to FIG. 1, a graph process system 100 is depicted in accordance with an aspect of the claimed subject matter. Graphs and related trees are oft-utilized structures in the computer world. For example, modern object-oriented programs allow and enable creation and utilization of complex graphs of objects some of which are dynamically typed. Furthermore, state machines can be represented as graphs. Indeed, state machine graphs can be utilized to process object graphs. Here, the system 100 includes a process component 110 and a map component 120.

The process component 110 processes one or more graphs. More specifically, the process component 110 manages processing of graphs. Rather than including hardcoded graph functionality, the process component 110 can interact with the map component 120 to locate needed functionality. The map component 120 is a mechanism for capturing various graph related processing functionality. For example, the map component 120 can be embodied as a table or other structure of functions or methods indexed by some identifying information. Accordingly, the process component can lookup a mechanism designated for processing a node as a function of node identity, type, and/or context information, among other things, for instance. Upon identification, the process component can invoke such a mechanism to initiate processing of a node.

The map component 120 provides a level of indirection to graph processing. This makes graph processing system 100 extensible and able to support future changes. For example, changes can be made in the manner in which a node is processed by altering the associated process mechanism or mechanisms provided by the map component. Further, previously unknown nodes can be processed by adding an entry therefor in map component 120. Additionally, the map component 120 enables lightweight machines they require a minimum number of process mechanisms.

In terms of automata, the process component 110 can be represented a state machine for processing graphs or a process graph itself. Instead of requiring, the state machine to be hard coded to include functionality necessary to process the graphs it can be designed to consult and/or interact with a modifiable map component 120. In one particular embodiment, such interaction can occur dynamically at runtime. By way of example and not limitation, upon identification of a node for processing, the state machine can identify a node type (e.g., reflection), lookup a process mechanism for that type, and initiate execution of such a mechanism. In object-oriented programming terms, this can correspond to virtual dispatch associated with implementation of polymorphism where a virtual method/function is bound to an implementation at runtime as a function of type.

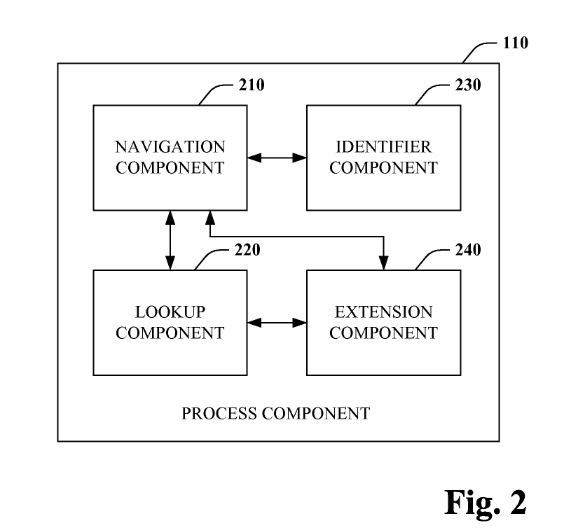

FIG. 2 depicts a representative process component 110 in accordance with an aspect of the claimed subject matter. As previously mentioned, the process component 110 manages processing of graphs. The process component 110 includes a navigation component 210 communicatively coupled to lookup component 220. The navigation component navigates a graph to effect ordered processing thereof. For example, the navigation component 210 can provide a means for depth-first or breadth-first traversal. The navigation component 210 can call upon the lookup component 220 to identify one or more processing mechanisms for a node, upon transitioning to a new state for example. The lookup component 220 receives, retrieves or otherwise acquires some information regarding a particular node and optionally some contextual information and identifies one or more designated processing mechanisms for the node.

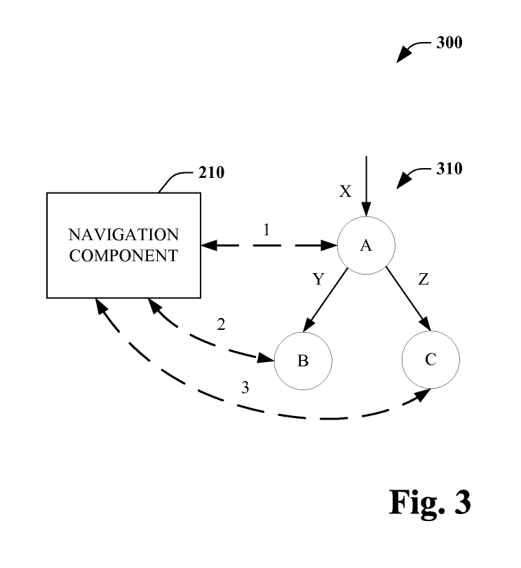

Referring briefly to FIG. 3 a graphical depiction of graph traversal 300 is illustrated in accordance with a claimed aspect. In this case, the navigation component 210 implements a depth-first traversal or a simple three-element graph 310. First, the navigation component 210 identifies the initial or root node “A.” Subsequently, the navigation component 210 can call upon the lookup component 220 of FIG. 2 to identify a processing mechanism for a node of type “A.” An identified process mechanism can then be executed to process the root node. Next, child node “B” can be navigated to and a process mechanism identified and applied for this particular node. Similar processing can subsequently be applied to child node “C.” It is further to be appreciated that processing can be recursive in nature or in accordance with a recursive descent pattern. Accordingly, processing of a first node may require a recursive call to process another node or object.

Returning to FIG. 2, the navigation component is also communicatively coupled to identifier component 230. Identifier component 230 provides a unique identifier to nodes as a function of traversal to facilitate cycle breaking and generation of a tree from a graph. For example, during a depth-first traversal or the graph unique numbers can be assigned to nodes that are capable of cycling and such identifiers can be employed in a tree to maintain cyclic information. This is particular useful during serialization/deserialization as will be described further infra.

The process component 110 also includes an extension component 240 communicatively coupled to the lookup component 220 and/or navigation component 210. The extension component 240 provides a manner to further extend processing of nodes. More specifically, the extension component 240 enables processing mechanisms to be added to a system for use in node processing including a custom mechanism to override default processing and additional mechanism for processing of nodes unknown to a local system, inter alia. In one instance, if the lookup component 220 is unable to find a processing mechanism the extension component 240 can be employed to acquire that mechanism from an outside service.

In addition to adding extensibility, the extension component 240 allows the process component 110 to be lightweight. In other words, a system need not include any more process ability than is necessary at a time. Additional functionality can be added as needed. Furthermore, it should be appreciated the extension component 420 can be available statically at compile type and/or dynamically at runtime. Where the applied at runtime, such functionality may be considered double virtualization where the first instance of virtualization exists as a result of separation of an processing component from node process mechanisms. Further yet, it is to be appreciated that the extension component 420 facilitates interaction across asymmetric environments or different execution contexts or environments since needed process mechanism can be easily added.

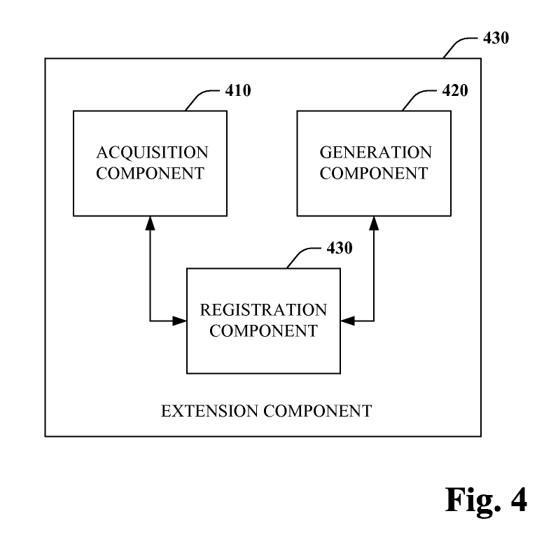

FIG. 4 illustrates a representative extension component 430 in accordance with an aspect of the claimed subject matter. As shown, the extension component 430 includes acquisition component 410, generation component 420, and registration component 430.

The acquisition component 410 is a mechanism for receiving, retrieving or otherwise obtaining a process mechanism from outside a graph process system. In one instance, the acquisition can obtain a process mechanism from a user that wishes to customize processing and/or afford additional processing power. Additionally or alternatively, the acquisition component 410 can acquire a processing mechanism from a dedicated server. For example, a server can provide a service to afford processing mechanisms upon request. In a specific instance, the server can be executing a server side portion of a distributed application. Still further yet, the acquisition component 410 can mine network resources in an attempt to locate a desired processing mechanism.

The generation component 430 is a mechanism for automatically generating a process mechanism. The generation component 420 can employ rule-based knowledge, inference, or machine learning techniques, among other things to produce a processing mechanism. Such ability can be provided by a local system or accessed externally. For example, where a process mechanism exists for a general node of a particular type, the generation component 420 can produce a specific process mechanism from that mechanism and or other internally or externally collected knowledge or context information. Some objects can even carry information useful for producing a mechanism to process them.

The registration component 430 interacts with both the acquisition component 410 and the generation component 420 to make process mechanisms available for use. In particular, upon acquisition or generation of a process mechanism the registration component 420 can register the new mechanism with the system to enable current and/or future utilization. Registration can involve persisting the mechanism to a particular location and adding an entry in a map pointing thereto, among other things.

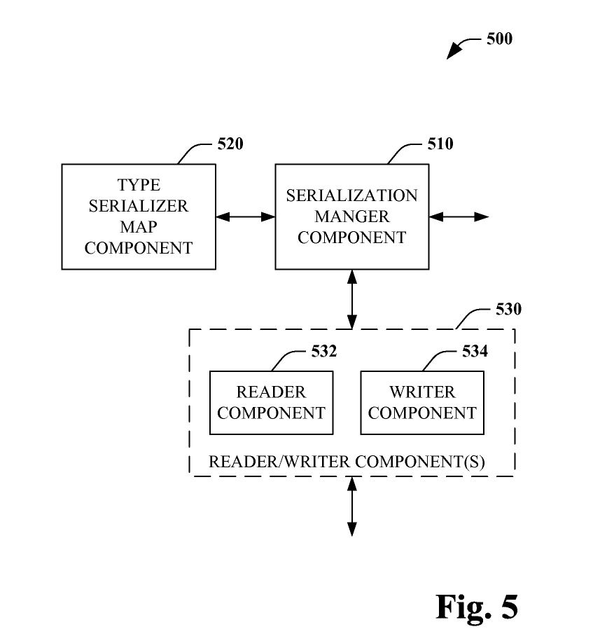

Referring to FIG. 5, a serialization system 500 is depicted in accordance with an aspect of the claimed subject matter. As previously indicated, one particular instance of virtual automata includes serialization and deserialization. Here, serialization manager component 510 and type serializer map component 520 correspond to specific instances of the process component 110 and map component 120 of FIG. 1, respectively. The serialization manager component 510 manages serialization of an object graph, for example. The type serializer map component 520 affords a mechanism for housing and provisioning object serializers as a function of type, for instance. Accordingly, upon navigation to a particular object node, its type can be determined and employed to look up one or more type serializer components, or simply type serializers, for use in serializing and/or deserializing that node.

The serialization system also includes a reader component 532 and writer component 534 collectively referred to as reader/writer component(s) 530. The reader component 532 provides a mechanism to read a particular transfer syntax and the writer component 534 writes the particular transfer syntax. Accordingly, the serialization performed by the serialization manager component 510 in conjunction with type serializer map component 520 is performed at a higher level than the actual transfer syntax. In other words, mechanisms are focused on efficiently transitioning between an actual object instance and a transfer syntax. Furthermore, the serialization system 500 becomes even more extensible by segmenting the transfer syntax from serialization. Now, various transfer syntaxes can be easily plugged in. In this manner, if more efficient transfer syntax is developed, it can be provide and employed easily by the serialization system 500.

Further details are now provided with respect to a particular implementation of the serialization system 500 to further clarify aspects of the claimed subject matter. Of course, the details are merely exemplary and not meant to limit the claimed subject in any manner.

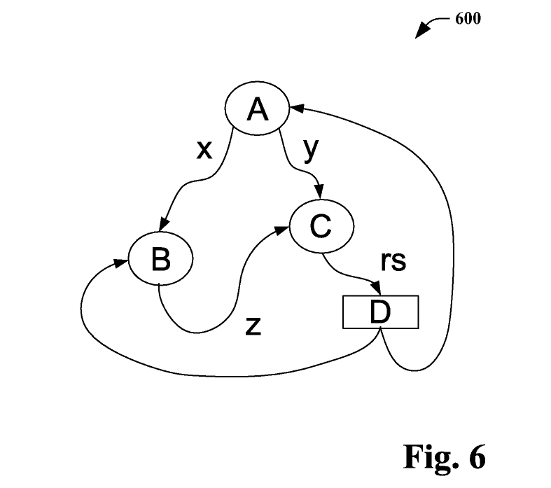

The underlying assumption is that a data model consists of edge labeled graphs to according to an abstract syntax “Graph::=Object(Member Graph)*|Array Graph*”. An exemplary graph 600 is illustrated in FIG. 6 showing objects represented as circles and arrays as rectangles. The types are designated by the letters therein. For example, the rectangle with a “D” corresponds to an array of elements of type “D.”

Provided below are exemplary reader and writer interfaces that describe how individual “tokens” are read from an ambient input stream and written to an ambient output stream. Note how the reader and writer interfaces (and serialize and deserialize interfaces further below) are dual to each other. In contrast to other serialization frameworks that assume that that serialized data is self-describing, the design described herein can rely on the fact that the serializers and deserializers are defined pair-wise and in lockstep.

| public interface IObjectReader | |
|---|---|
| { | |
| void | ReadMemberName(string name); |
| bool | TryReadMemberName(string name); |
| string | ReadPrimitive( ); |
| void | ReadSeparator( ); |
| void | ReadBeginObject( ); |
| bool | TryReadEndObject( ); |
| bool | TryReadNull( ); |
| void | ReadBeginArray( ); |
| bool | TryReadEndArray( ); |
| object | GetFromCache(int id); |

```
  void AddToCache(object o);
}
public interface IObjectWriter
{
  void WriteNull( );
  void WriteSeparator( );
  void WritePrimitive(string primitive);
  void WriteBeginArray( );
  void WriteEndArray( );
  void WriteMemberName(string name);
  void WriteBeginObject( );
  void WriteEndObject( );
  int TryGetObjectID(object o);
  void AddToCache(object o);
}
```

To serialize an object graph, a user passes a writer for a particular transfer syntax to the serialization manager component 510 along with a root of the object graph. The serialization manager component 510 can then dispatch based on type to the appropriate type serializer provided by type serializer map component 520. The type serializer knows how to serialize that specific type (e.g., dynamic) and delegates back to the serialization manager component 510 for all contained types. The type serializers need not know how to serialize directly to a transfer syntax but rather delegate to the writer component 534 to do the work.

Similarly, to deserialize, a user passes a reader to the serialization manager component 510, which then delegates off to the appropriate type serializer based upon the encoded dynamic type, for example. The type serializer then uses the reader to read various parts of the object. Furthermore, the type serializer delegates back to the serialization manager component 510 for its component parts.

Provided below are exemplary interfaces that may be implemented for type serializers.

```
public interface ITypeSerializer
{
  void Serialize(ISerializer serializer
        , IObjectWriter writer
        , object value);
  object Deserialize(ISerializer serializer
          , IObjectReader reader);
  string SerializationID { get; }
  string DeserializationID { get; }
}
public interface ITypeSerializer<T> : ITypeSerializer
{
  void Serialize(ISerializer serializer
        , IObjectWriter writer
        , T value);
  new T Deserialize(ISerializer serializer
          , IObjectReader reader);
}
public interface ISerializer
{
  void Serialize<U>(IObjectWriter writer, U value);
  U Deserialize<U>(IObjectReader reader);
  void RegisterTypeSerializer(ITypeSerializer serializer);
}
```

The above design allows for full streaming implementations of serialization and deserialization, that is, there is no need to buffer any values during the process. Deserialization corresponds to recursive descend parsing with limited look ahead (e.g., the “TryReadXXX” methods) while serialization corresponds to top-down, left-to-right single-pass pretty printing of parse trees. Implementations of serializers and deserializers correspond to non-terminals of a grammar.

Referring back to FIG. 2 briefly, the serialization manager component 510 can include like elements including the navigation component 210, lookup component 220, identifier component 230, and extension component 240, as previously described. Serialization and deserialization can be effected utilizing the navigation component 210 to perform a depth-first traversal, for example, of a graph employing the lookup component to process nodes utilizing a type serializer. In some instances, graphs will include cycles. Prior to transmittal, cycle need to be eliminated but there presence preserved to enable correct reconstitution. This can be done utilizing the identifier component to inject identifiers into a graph and effect transformation from a graph into a tree. The following provides details on how this can be accomplished in one exemplary scenario. Of course, the claimed subject matter is not meant to be limited thereby.

To write an object graph, begin by visiting the root of the graph and then traverse the graph in depth-first order. Each node that could begin a cycle is added to a cache and assigned an identifier such as a number based upon its appearance in the tree. This can be referred to herein as a navigation or order identifier. So the first such node is given a 0, the second such node is given a 1, and so on. If the node is visited again during serialization, then instead of serializing the node a second time, its implicit depth-first traversal number is used instead and there is no need to recursively serialize the child nodes. This process creates a spanning tree from the graph where some of the leaf nodes are the implicit order ids. Note that the depth-first numbering is a very convenient and efficient way to create a unique id for each node in a graph.

To reconstitute the graph upon deserialization, the tree is again visited by an in-order traversal. For each node that could be a cycle, it can be put at in a list. When an ID is visited, a look up of the corresponding node in the list can be performed and the result used in the resulting graph. Furthermore, objects should be added to cache before visiting their children (in both serialization and deserialization cases) as is common in co-inductive algorithms. This can correspond to the pushdown portion of an automaton when speaking in those terms.

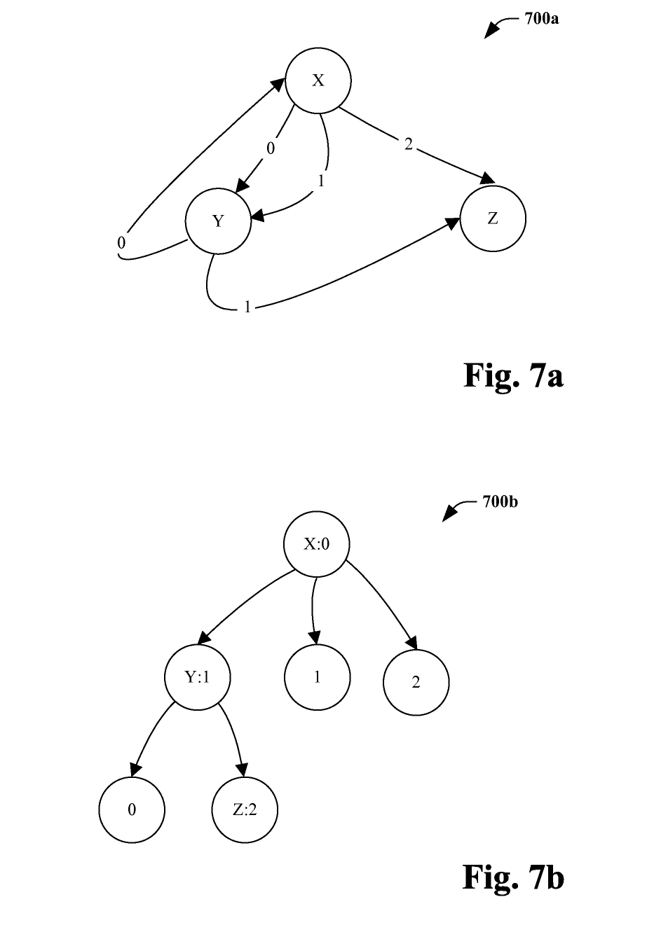

What follows is an example of a cycle breaking utilizing order identifiers to generate a spanning tree in accordance with an aspect of the claimed subject matter. Consider the following pseudo code that defines a graph 700a as shown in FIG. 7a:

var z = new object( );
var y = new object[2];
var x = new object[3];
y[0] = x;
y[1] = z;
x[0] = y;
x[1] = y;
x[2] = z;
var serializer = new TestSerializer( );
var memo = serializer.Serialize(x);

The graph 700a has only three object nodes “x,” “y,” and “z” and yet is quite complicated. This is a graph not a tree. During serialization, the cycle can be broken with order identifiers to produce a tree. Below is an example of a serialization utilizing a JSON (JavaScript Object Notation):

{_type:“System.Object[ ]”, length:“3”,_array:[{_type:“System.Object
[ ]”,_length:“2”,_array:[{_id:“0”},{_type:“System.Object”}]},{_id
:“1”},{_id:“2”}]}

Basically, this says that the root of this graph “x” is an object array including three things. The first thing is of type object array, which has two things corresponding to “y.” Then, it denotes that inside this object array the first thing is a back pointer to id zero. Graph or tree 700b of FIG. 7b depicts this graphically.

The graph 700a is processed as follows to return the serialized version above and as shown in 700b. In accordance with a depth-first traversal, root node “x” is viewed first and assigned an identifier zero or “x:0.” Next, “y” is visited and assigned an identifier one or “y:1.” Continuing, the object graph reverts back to the root “x.” Since this was already visited and assigned an order id zero a placeholder is inserted including the id zero representative of the zeroith object. Subsequent traversal discovers object “z,” which has not yet been visited and is assigned a numerical identifier two. In accordance with depth-first traversal, we pop back up to “x.” Next, since “y and “z” have already been visited and assigned ids, those identifiers are provided in separate nodes.

In essence, the depth-first navigation numbers are used as implicit identifiers. Accordingly, new ids need not be generated to break cycles and turn a graph into a tree. Stated differently, a graph is turned into a spanning tree utilizing depth-first numbers to represent back edges that would turn the spanning tree into a graph.

This is quite different from conventional mechanism. Usually, what people do is store information out-of-band from the tree as a separate thing like a table. Alternatively, rather than encoding ids, all objects are stored without links and keys encoding positions are stored separately. Utilizing depth-first numbering enables streaming. Streaming basically means left to right top to bottom traversal. The only thing that is used here is knowledge about previous visits in a tree. Accordingly, nodes can be streamed out because if it is visited again only its identifier is needed.

Returning to FIG. 5, it is to be noted that there are several extension points in this system. Users can implement custom reader/writer pairs so that new transfer syntax or more efficient translation can be supported. Type serializers can be written and registered with the serialization manager component 510 to allow custom serialization of the types. Further, the serialization manager component 510 can be customized through inheritance and/or delegation to handle new types on the fly. Further yet, the system 500 facilitates code generation because of its inherent simplicity and relying intrinsically on the dual nature of the reader and writer operations, the abstraction of the type serializers, and the extension points provided in the serialization manager component 510.

Furthermore, when the serialization manager component 510 is asked to serialize/deserialize a type for which a type serializer does not exist, a fallback can be implemented to create and register (for future use) a type serializer on the fly using something like reflection and dynamic code generation. The generated code may use unsafe methods for construction when a type does not provide a default constructor or has private members. If one of the participating environments does not know about the types because it is a different runtime then it can call a service that does know about the type. The service then generates the code and possibly translates it for use by the environment. This enables arbitrary type serialization while acknowledging that some environments cannot know the structure of the types (or do not need to carry around all the metadata to generate serializers).

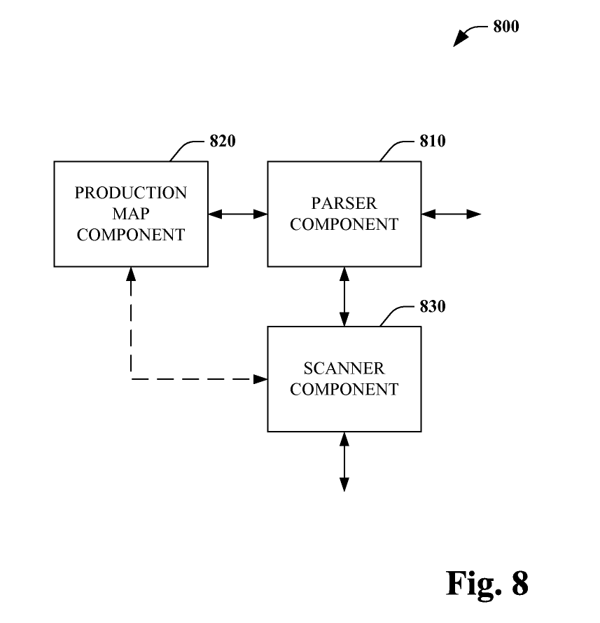

Turning to FIG. 8, a scanning/parsing system 800 is illustrated in accordance with an aspect of the claimed subject matter. Again, system 800 represents another instance of the more general virtual automaton previously described. Here, the parser component 810 and the production map component 820 correspond to the process component 110 and map component 120 of FIG. 1. The parser component 820 analyzes tokens provided by the scanner component 830 in accordance with production rules corresponding to a particular grammar provisioned by the production map component 820. In one embodiment, the parser component 810 can be a recursive decent parser (e.g., top to bottom) with an escape in the recursion to the production map component 820. In other words, calls to productions can be virtualized as a function of input. This provides an open world assumption in which there is no limit to extensibility. A production need not be known beforehand rather it can simply be looked up via the production map component 820. Instead of making calls directly, they are virtual.

By contrast, conventional recursive decent parsers assume a closed world. They assume availability of a whole grammar when a parser is generated. In this case, each non-terminal corresponds to a function and whenever it tries to parse another non-terminal, it calls that function recursively. Since the functions are mutually recursive one cannot later add another production, because it did not exist when the first set of mutually recursive functions were produced.

It is also to be appreciated that the scanner component 830 can be implemented in accordance with the virtual automata in a similar manner as the parser. For example, upon receipt of input production rules identifying tokens can be called from the map component 820, for example. Again, the same kind of recursive analysis with an escape to the production rules can be utilized.

It is to be noted and appreciated that a variety of other machines, applications or the like can be implemented in accordance with the virtual automaton implementation pattern in a similar or congruous manner to serialization/deserialization, parsing and scanning all of which are to be considered within the scope and spirit of the claimed subject matter. For example, compression, workflow processing, and process migration, load balancing or other processing where there are or can be graphs of processes, among other things.

By way of example and not limitation, compression can be implemented in this manner. Rules or references to rules can be stored in a table or other structure. These rules can define how particular pieces or types of data are transformed. The process portion, compression, can call these rules virtually to compress data. Furthermore, rules can be added to govern compression as discovered. For instance, if a string is viewed twice it can be stuck in a map with shorter code that can replace it. When that string is subsequently encountered, the compression process recognizing the new rule can replace the string with the compressed version.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the generation component 620 can employ such mechanism to facilitate generation of a desired process mechanism.

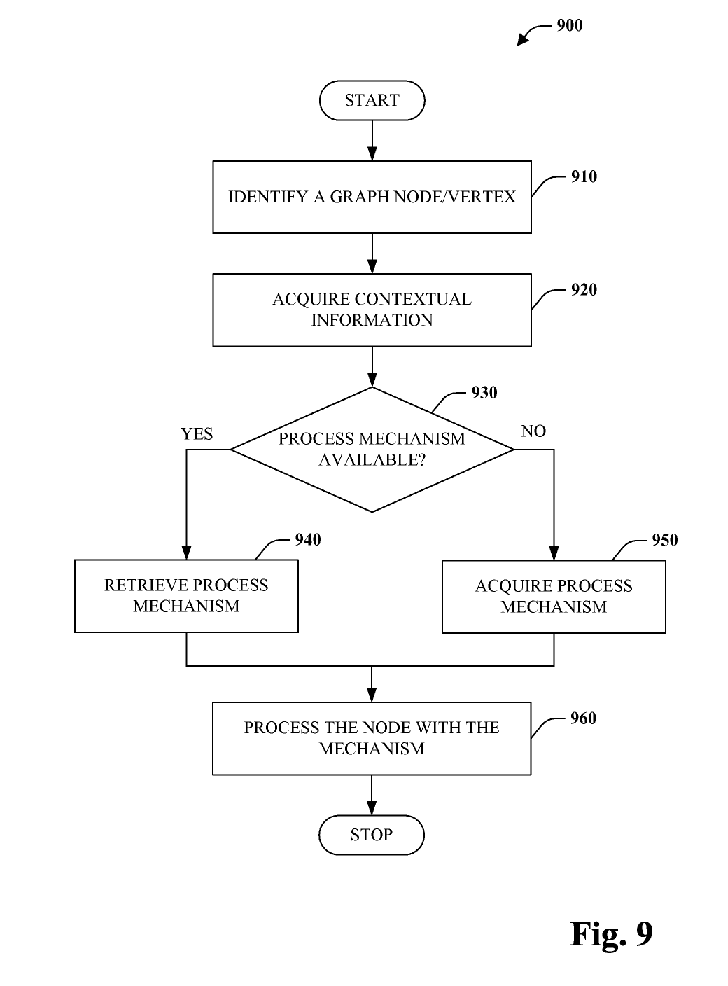

In view of the exemplary systems described supra, methodologies that may be implemented in accordance with the disclosed subject matter will be better appreciated with reference to the flow charts of FIGS. 9-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a graph processing method 900 is illustrated in accordance with an aspect of the claimed subject matter. At reference numeral 910, a graph node or vertex is identified. Contextual information such as node identity or type, among other things, can be acquired at reference numeral 920. In one instance, a reflection (or a limited version thereof) can be utilized to determine a runtime type associated with a node. Additionally or alternatively, contextual information can be inferred from processing context or acquired from an entity (e.g., server, service, user . . . ).

At numeral 920, a determination is made as to whether a process mechanism is available to process the particular node. This can correspond to referencing a map including process mechanism indexed contextual information such as type, among other things. It is to be noted that process mechanisms may be hierarchically indexed. For example, a process mechanism can be indexed by type and additional contextual information such that different process mechanisms are applicable for given type depending on other contextual information. A concrete example of contextual information can be direction or destination. For instance, data destined for a server can be serialized including a credit card number. However, data destined for a client from a server is serialized where credit card information is excluded.

If the process mechanism is available (“YES”), the method continues at reference 920 where the mechanism is retrieved. Alternatively, if the mechanism is not available (“NO”), the mechanism is acquired at 950. In one particular instance, acquisition can encompass requesting such a mechanism from a server and/or service. However, acquisition is not limited thereto. For example, the mechanism can be requested from a user or automatically generated.

Upon retrieval or acquisition of the process mechanism, it can be executed to process the identified node at reference numeral 960. It is to be appreciated that method 900 can be executed in a recursive fashion. For example, it can be called again to process a dependent or contained node.

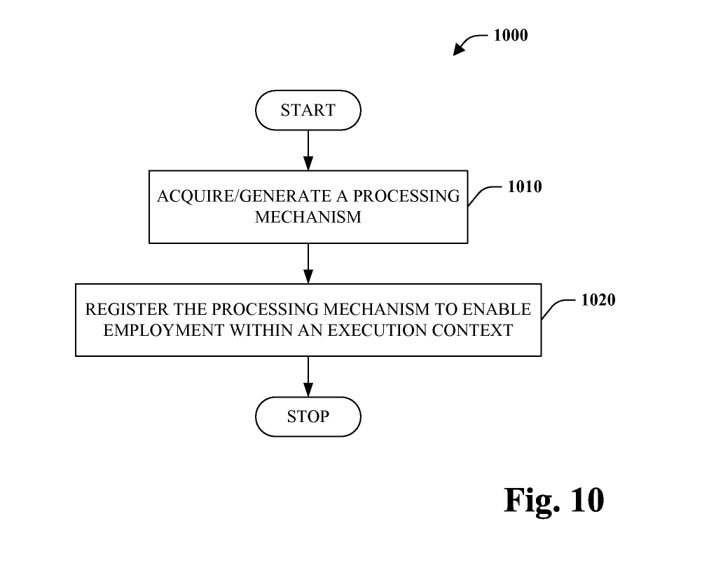

FIG. 10 is a flow chart diagram of a method of extending process capability in accordance with an aspect of the claimed subject matter. At reference numeral 1010, a process mechanism can be acquired or generated. In one instance, a process mechanism can be received from a user desiring to override default with custom functionality or add additional functionality. Additionally or alternatively, a process mechanism can be acquired from a server, service or generated in response to a request for such functionality at runtime, for example. In one specific embodiment, a client side portion of a distributed program can receive, retrieve, or otherwise acquire a process mechanism from a server side portion of the program. Where the client and server are in different execution contexts, the process mechanism can be generated in an appropriate execution format (e.g., language, environment . . . ). At numeral 1020, the acquired or generated process mechanism is registered with a system to enable future employment within an execution context. For instance, the process mechanism can be saved to a local storage medium and/or or within a mapping construct indexed by appropriate context information.

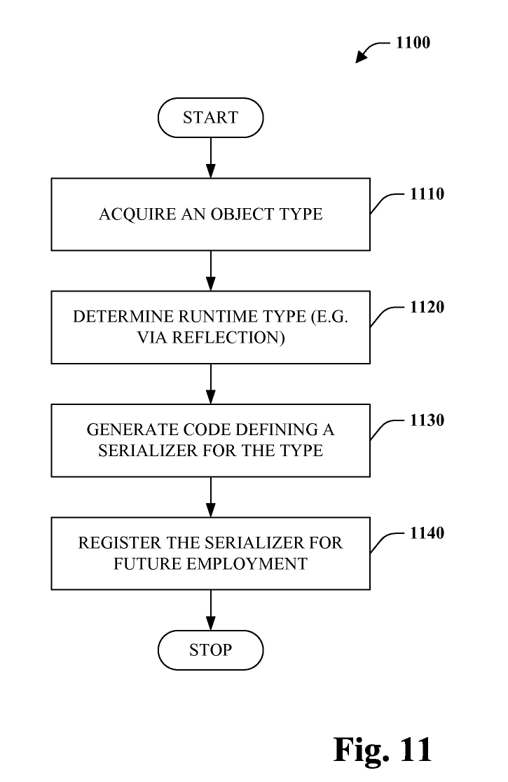

FIG. 11 depicts a method of process mechanism generation in accordance with an aspect of the claimed subject matter. At numeral 1110, an object is received, retrieved, or otherwise acquired. The type and/or other contextual information is acquired at reference 1120. In accordance with one embodiment, reflection can be employed to identify a runtime type. At reference numeral 1130, a code is generated defining a serializer or other process mechanism. In one instance, the object can carry information to facilitate construction of such a mechanism. Additionally or alternatively, rules and/or inferences can be employed to produce the mechanism as a function of other available information including like mechanisms. The generated serializer or process mechanism is subsequently registered with a system for future employment at numeral 1140.

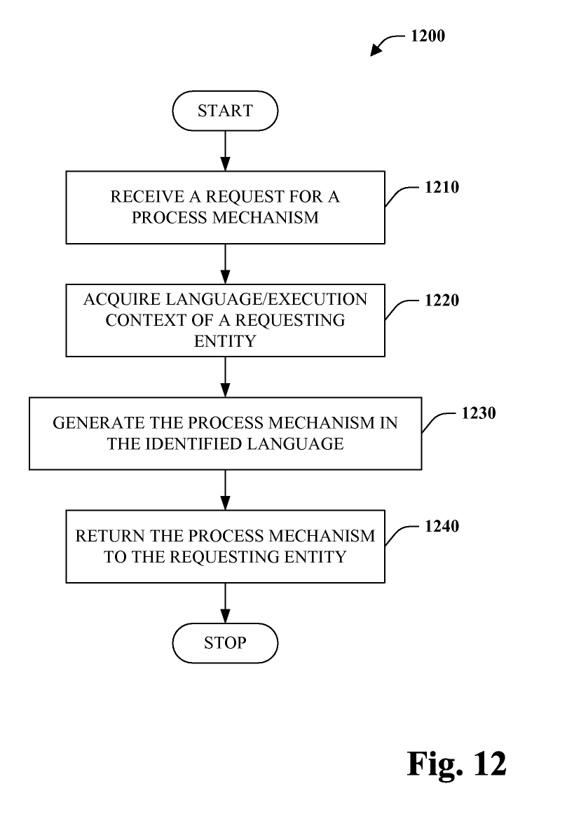

FIG. 12 illustrates a method 1200 for provisioning a process mechanism. At reference numeral 1210, a request is received for a process mechanism such as but not limited to a type serializer or production. At numeral 1220, the language and/or execution context of a requesting entity is received, retrieved, or otherwise acquired. At reference 1230, the process mechanism is generated in the language or execution context of the requesting entity. For example, if a requesting program is executed in JavaScript (a.k.a. ECMAScript) within a browser, a JavaScript version of the process mechanism can be produced. At numeral 1240, the generated process mechanism is returned to the requesting entity.

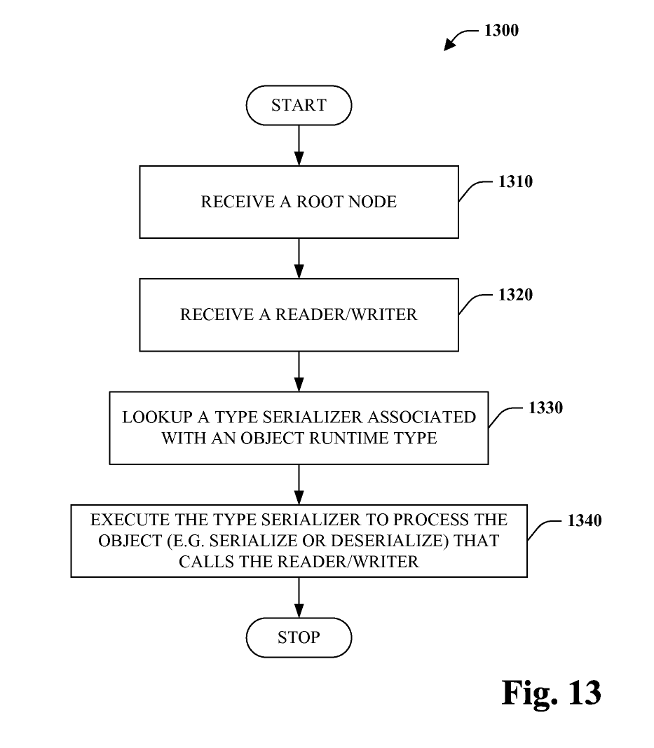

FIG. 13 illustrates a serialization method 1300 in accordance with an aspect of the claimed subject matter. At reference numeral 1310, a root node of an object graph is received. A reader and/or writer are received at reference 1320. The reader is a mechanism for reading data serialized in a particular syntax while the writer can write data to in that same syntax. A type serializer is looked up for a particular object type such as a runtime type at reference 1330. For example, a map, table, or other like structure can be queried with the type to identify a type serializer. Furthermore, the type serializer can specify mechanisms for both serialization and deserialization. At reference numeral 1340, the type serializer is executed to process the object (e.g., serialize or deserialize). Furthermore, the type serializer can call the reader and/or writer to read or write in a specific transfer or wire syntax.

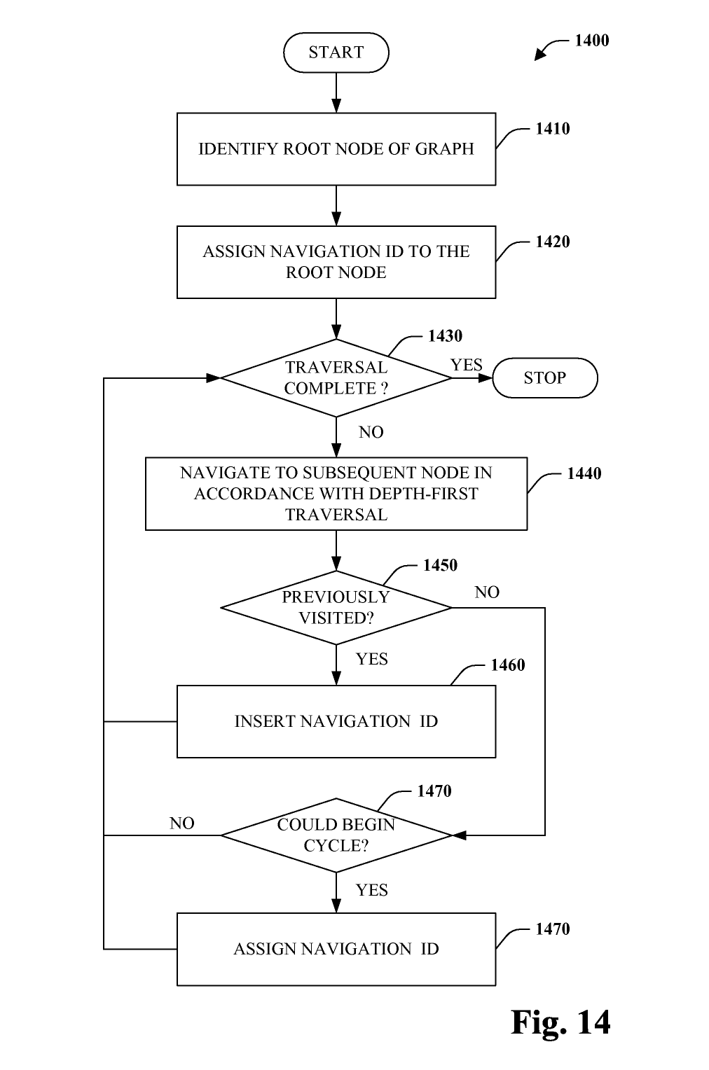

Referring to FIG. 14, a method of graph serialization 1400 potentially in the presence of cycle is illustrated in accordance with an aspect of the claimed subject matter. In other words, the graph is converted to a tree at some point during serialization. At reference numeral 1410, a root of an object graph is identified. At numeral 1420, a navigation identifier (also referred to herein as an order or traversal identifier) is assigned to the root node. In one instance, the identifier can be cached for later reference and utilization. In accordance with one embodiment, the navigation identifier can be a numeric value indicative of position within the graph. For example, the navigation for the root node can be zero. A check is made at 1430 as to whether graph navigation or traversal is complete. If yes, the method terminates. If no, the method continues at reference numeral 1440 where the graph is navigated to the next node in accordance with a depth-first traversal (top-down, left-right), for instance. At numeral 1450, a determination is made concerning whether the node was previously visited. If yes, the navigation id associated with the previously visited node is inserted at 1460 as a node, for example. Subsequently, the method can continue at numeral 1430. If no, the method continues at reference 1470 where it is determined whether or not a cycle could begin with the given node. If the answer is no, the method continues at numeral 1430. Alternatively, if the answer is yes, the method proceeds to reference numeral 1480 where a navigation identifier is assigned for that node. The method continues back at reference numeral 1430 subsequently. In accordance with an aspect of the claims, the method 1400 can be executed in one pass and supports streaming.

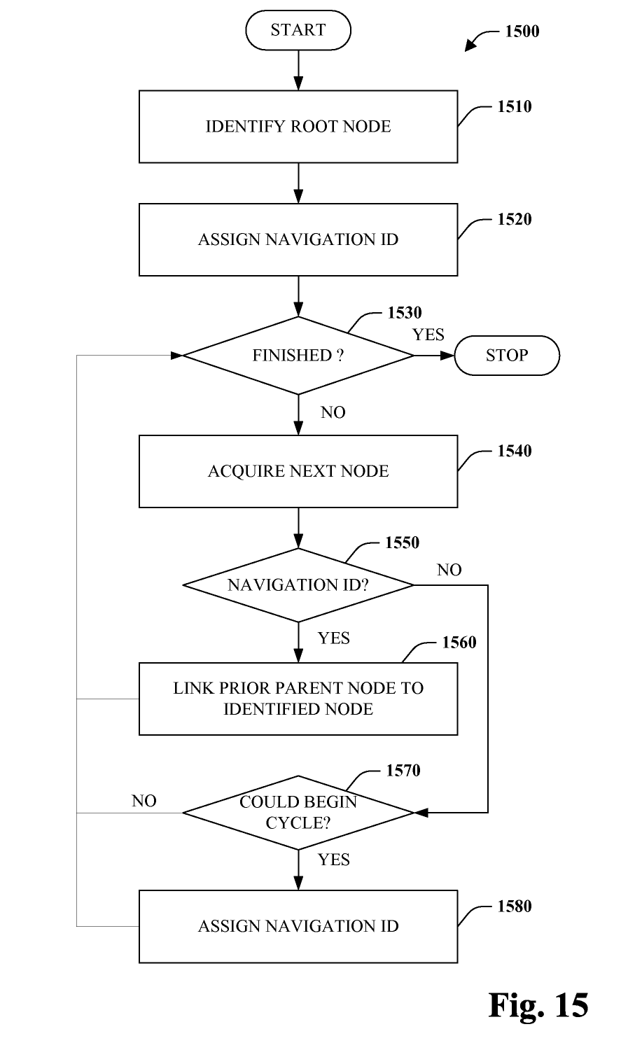

FIG. 15 is a graph-based deserialization method 1500 according to an aspect of the claimed subject matter. At reference numeral 1510, a root node is identified from the serialized data. At navigation identifier is assigned to the root node as a function of is position and/or as indicated in the serialized data at reference 1520. This information can be cached or otherwise saved for later use. At numeral 1530, a check is made of whether or not serialization processing is finished. Among other things, this determination concern whether there is more data to process. If processing is complete, the method simply terminates. Otherwise, the method continues at reference 1540 where the next node is acquired from the serialized data. A determination is made at 1550 as to whether the next node includes a navigation id. If yes, a link is established between the prior parent node and the node identified by the navigation id at numeral 1560. In this manner, a cycle is reconstituted. If there is no navigation identifier (“NO”), the method proceeds at 1570 where a determination of whether a cycle could begin with the node. If no, the method continues at 1530. If yes, the method continues at 1580 where a navigation identifier is assigned to the node and the method proceeds at 1530.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

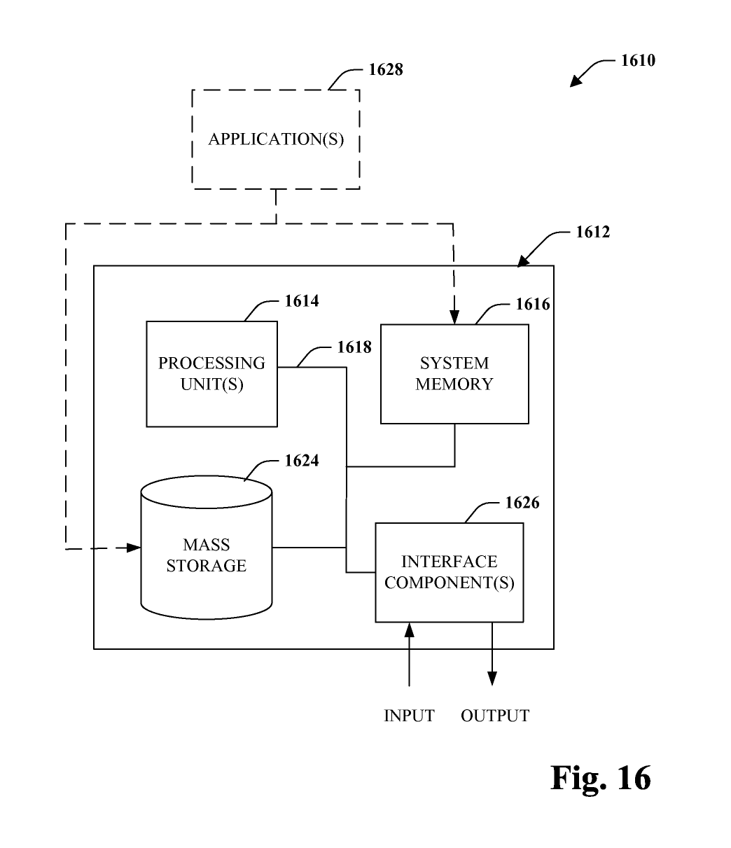

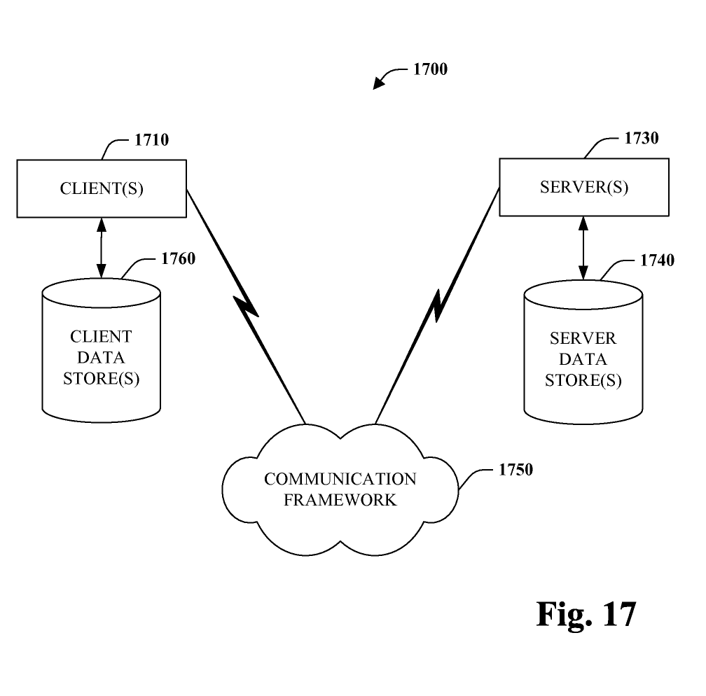

In order to provide a context for the various aspects of the disclosed subject matter, FIGS. 16 and 17 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 16, an exemplary environment 1610 for implementing various aspects disclosed herein includes a computer 1612 (e.g., desktop, laptop, server, hand held, programmable consumer or industrial electronics . . . ). The computer 1612 includes a processing unit 1614, a system memory 1616, and a system bus 1618. The system bus 1618 couples system components including, but not limited to, the system memory 1616 to the processing unit 1614. The processing unit 1614 can be any of various available microprocessors. It is to be appreciated that dual microprocessors, multi-core and other multiprocessor architectures can be employed as the processing unit 1614.

The system memory 1616 includes volatile and nonvolatile memory. The basic input/output system (BIOS), containing the basic routines to transfer information between elements within the computer 1612, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1612 also includes removable/non-removable, volatile/non-volatile computer storage media. FIG. 16 illustrates, for example, mass storage 1624. Mass storage 1624 includes, but is not limited to, devices like a magnetic or optical disk drive, floppy disk drive, flash memory, or memory stick. In addition, mass storage 1624 can include storage media separately or in combination with other storage media.

FIG. 16 provides software application(s) 1628 that act as an intermediary between users and/or other computers and the basic computer resources described in suitable operating environment 1610. Such software application(s) 1628 include one or both of system and application software. System software can include an operating system, which can be stored on mass storage 1624, that acts to control and allocate resources of the computer system 1612. Application software takes advantage of the management of resources by system software through program modules and data stored on either or both of system memory 1616 and mass storage 1624.

The computer 1612 also includes one or more interface components 1626 that are communicatively coupled to the bus 1618 and facilitate interaction with the computer 1612. By way of example, the interface component 1626 can be a port (e.g., serial, parallel, PCMCIA, USB, FireWire . . . ) or an interface card (e.g., sound, video, network . . . ) or the like. The interface component 1626 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1612 to output device(s) via interface component 1626. Output devices can include displays (e.g., CRT, LCD, plasma . . . ), speakers, printers and other computers, among other things.

FIG. 17 is a schematic block diagram of a sample-computing environment 1700 with which the subject innovation can interact. The system 1700 includes one or more client(s) 1710. The client(s) 1710 can be hardware and/or software (e.g., threads, processes, computing devices). The system 1700 also includes one or more server(s) 1730. Thus, system 1700 can correspond to a two-tier client server model or a multi-tier model (e.g., client, middle tier server, data server), amongst other models. The server(s) 1730 can also be hardware and/or software (e.g., threads, processes, computing devices). The servers 1730 can house threads to perform transformations by employing the aspects of the subject innovation, for example. One possible communication between a client 1710 and a server 1730 may be in the form of a data packet transmitted between two or more computer processes.

The system 1700 includes a communication framework 1750 that can be employed to facilitate communications between the client(s) 1710 and the server(s) 1730. The client(s) 1710 are operatively connected to one or more client data store(s) 1760 that can be employed to store information local to the client(s) 1710. Similarly, the server(s) 1730 are operatively connected to one or more server data store(s) 1740 that can be employed to store information local to the servers 1730.

Client/server interactions can be utilized with respect with respect to various aspects of the claimed subject matter. By way of example and not limitation, data can be processed between a client 1710 and a server 1730 across the communication framework 1750. In one particular instance, serialized data can be streamed from the client 1710 to a server. Furthermore, the process mechanisms such as type serializers can be acquired by a client 1710 from a server 1730 by way of the communication framework 1750. In accordance with one embodiment, aspects of the claimed subject matter facilitate execution of a program specified for execution in one execution context and retargeted to at least one other. For instance, where a high-level object-oriented program is retargeted to execute in a browser scripting language support for efficient processing is desired.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A computer-implemented data process system, comprising:
a map component that provides node process mechanisms; and
a process component that interacts with the map component to identify and execute specific process mechanisms to process nodes of a graph in a recursive manner at runtime.

2. The system of claim 1, further comprising a navigation component that traverses the graph in a depth-first pattern to enable streaming.

3. The system of claim 1, further comprising an extension component to enable addition of process mechanisms to the map component.

4. The system of claim 3, further comprising an acquisition component that acquires a process mechanism from a server.

5. The system of claim 3, further comprising a component that generates an additional process mechanism.

6. The system of claim 1, the map component includes production rules and the process component parses and/or scans input as a function of the rules.

7. The system of claim 1, the map component includes type serializers and the process component manages serialization and/or deserialization based on the type serializers.

8. A serialization method, comprising:
acquiring a writer component to write output with in a specific transfer syntax;
looking up a type serializer for an object type of a node in an object graph; and
executing the type serializer to serialize the node, wherein the type serializer invokes the writer component.

9. The method of claim 8, further comprising performing a depth-first traversal of the object graph in furtherance of serialization thereof.

10. The method of claim 9, further comprising transforming the graph into a tree employing depth-first navigation identifiers to break cycles.

11. The method of claim 10, further comprising assigning an identifier to a node that could potentially begin a cycle.

12. The method of claim 11, further comprising inserting the identifier into a tree node to capture back edges.

13. The method of claim 9, further comprising serializing the object graph in one pass.

14. The method of claim 8, further comprising requesting the type serializer from an external source or generating the type serializer upon lookup failure.

15. The method of claim 14, further comprising registering the type serializer to enable future lookup.

16. A method of deserialization, comprising:
locating a type serializer as a function of an object type; and
executing the type serializer to deserialize an object, the type serializer invokes a reader component to read serialized data in a particular transfer sytnax.

17. The method of claim 16, further comprising constructing an object graph in a depth-first manner from a stream of serialized data.

18. The method of claim 17, further comprising reconstructing object graph cycles as a function of depth-first navigation identifiers.

19. The method of claim 16, locating the type serializer comprises retrieving the type serializer from an external service and registering the type serializer locally for future employment.

20. The method of claim 16, further comprising generating the type serializer and registering the generated serializer for subsequent use.
